(19) United States
(12) Patent Application Publication
(10) Pub. No.: US 2011/0045839 A1
(43) Pub. Date: Feb. 24, 2011

(54) GPS remote transmission method

(75) Inventor: Chia-Hua Chao, Chung Ho City (TW)

Correspondence Address: BACON & THOMAS, PLLC, 625 SLATERS LANE, FOURTH FLOOR, ALEXANDRIA, VA, 22314-1176, US

(73) Assignee: GLOBALSAT TECHNOLOGY CORPORATION, Chung Ho City (TW)

(21) Appl. No.: 12/461,704

(22) Filed: Aug. 21, 2009

(51) Int. Cl. H04W 24/00

(52) U.S. Cl. 455/456.1

(57) ABSTRACT

A GPS remote transmission method in which satellite positioning data received by a GPS is converted into a speech signal and transmitted to a proximal mobile telephone wirelessly for enabling the proximal mobile telephone to transmit the speech signal to a proximal base station, which transmits the speech signal to a distal base station through an exchange system so that the distal base station transmits the speech signal to a distal mobile telephone for transmission to a distal GPS, which converts the speech signal into satellite position data for display on a display screen thereof.

### BACKGROUND OF THE INVENTION

1. Field of the Invention

The present invention relates to GPS application technology and more particularly, to a GPS remote transmission method, which allows transmission of satellite positioning data from a proximal GPS to a distal GPS through mobile telephones and base stations.

2. Description of the Related Art

Following fast development of technology, many advanced electric and electronic products have been created and are intensively used in clothing, food, housing, transportation, education and entertainment industries to improve people's living standards. With respect to transportation, bus, train, urban mass transit system, airplane and ship are used to transport people. Further, most families have cars and motorcycles for use as personal transportation vehicles. When driving a car in a non-familiar place, the driver may lose his (her) direction. Therefore, people usually will use a map to help navigation. However, a map cannot give all navigation information required. However, people may still lose one's direction under the assistant of a navigation map when encountered a road widening, road remaking or road changing construction. Nowadays, GPS applications have been well developed to help navigation. Subject to the assistance of satellite positioning data, people will not lose one's direction when driving a car in a non-familiar place. Further, following the implantation of two days off weekly, people may invite their family members, friends and colleagues to drive cars in team for outdoor activities during holidays. When marching of a vehicle team, the team leader may use a GPS (global positioning system) to help navigation. During navigation, unexpected traffic conditions may happen, causing the members of the vehicle team unable to contact with one another. In actual practice, conventional GPS are still not satisfactory function and have drawbacks as follows:
(1) Conventional GPS simply can receive satellite positioning data. They cannot be used as a wireless communication device or satellite positioning data transmitter. Therefore, the functioning of conventional GPS is limited.
(2) During navigation of a vehicle team, one team member cannot know the locations of the other team members. When using a mobile telephone for voice contact during navigation, a mistake or misunderstanding may occur, causing the members of the vehicle team unable to find the way.

Therefore, there is a strong demand for a GPS navigation system that eliminates the aforesaid problems.

### SUMMARY OF THE INVENTION

The present invention has been accomplished under the circumstances in view. It is the main object of the present invention to provide a GPS remote transmission method, which is practical for use in a vehicle team in which each vehicle carries one GPS and one mobile telephone, facilitating management of the navigation of the team members and avoiding loss contact of any team member during navigation.

To achieve this and other objects of the present invention a GPS remote transmission method enables a GPS to integrate convert satellite positioning data by means of a microprocessor, to convert the data into a speech signal by means of a converter and to transmit the speech signal to a proximal mobile telephone by means of a wireless receiver/transmitter, so that the proximal mobile telephone can transmit the speech signal to a proximal base station for enabling the proximal base station to transmit the speech signal to a distal base station through an exchange system and then the distal base station transmits the speech signal to a distal mobile telephone for transmission to a distal GPS, which converts the speech signal into satellite position data for display on a display screen thereof.

Further, the invention allows two-way signal transmission between a GPS and a mobile telephone by means of the operation of a converter to convert received signal from a wireless receiver/transmitter thereof into a digital signal for recognition by a microprocessor. If the signal is recognized to be a voice signal, the speaker and microphone of the GPS or mobile telephone are driven for talk.

### BRIEF DESCRIPTION OF THE DRAWINGS

FIG. 1 is a flow chart of the present invention.

FIG. 2 is a schematic drawing showing an application example of the present invention.

FIG. 3 is a schematic drawing showing another application example of the present invention.

FIG. 4 is a circuit block diagram of a control circuit module for GPS according to the present invention.

FIG. 5 is a circuit block diagram of an alternate form of the control circuit module for GPS according to the present invention.

FIG. 6 is a circuit block diagram of a circuit module for mobile telephone according to the present invention.

FIG. 7 is a circuit block diagram of an alternate form of the circuit module for mobile telephone according to the present invention.

### DETAILED DESCRIPTION OF THE PREFERRED EMBODIMENT

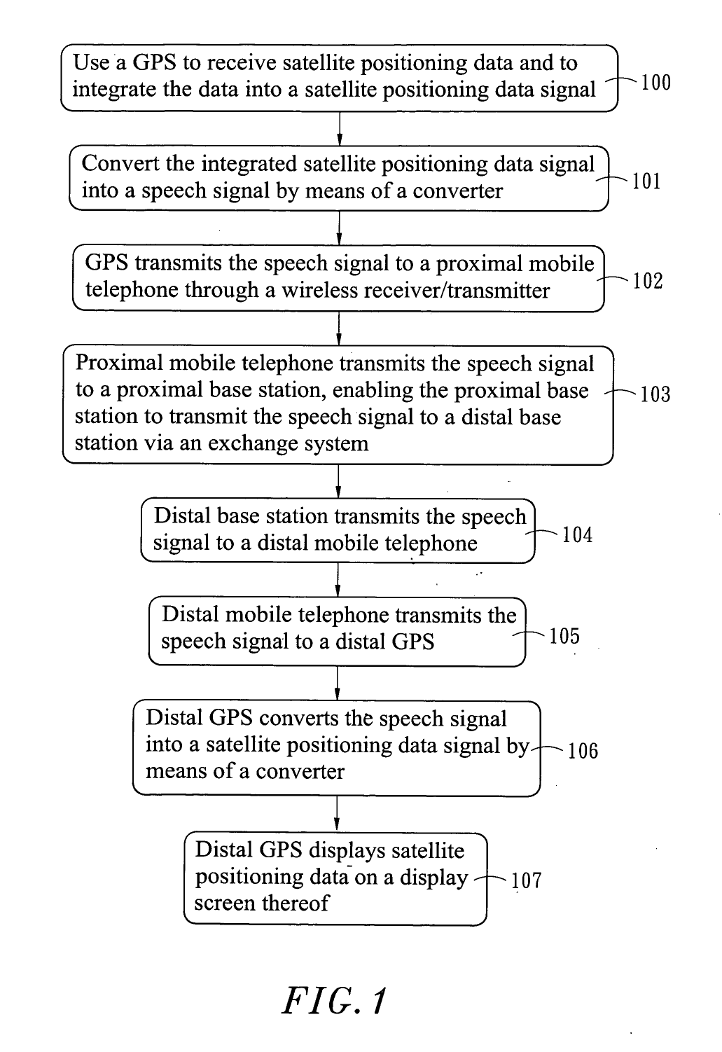

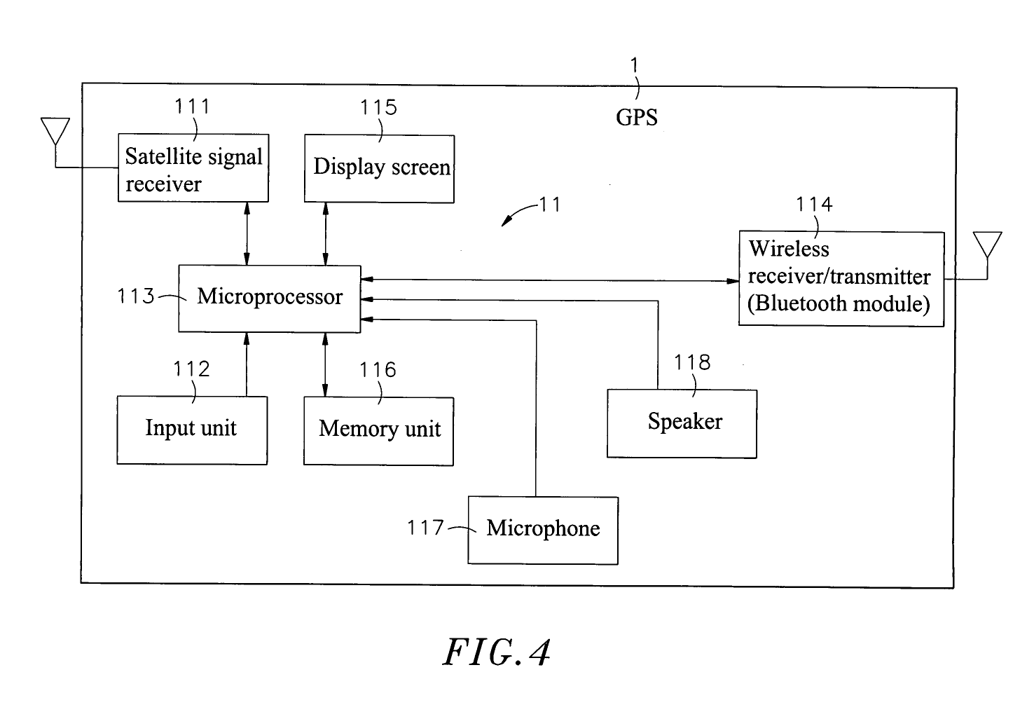

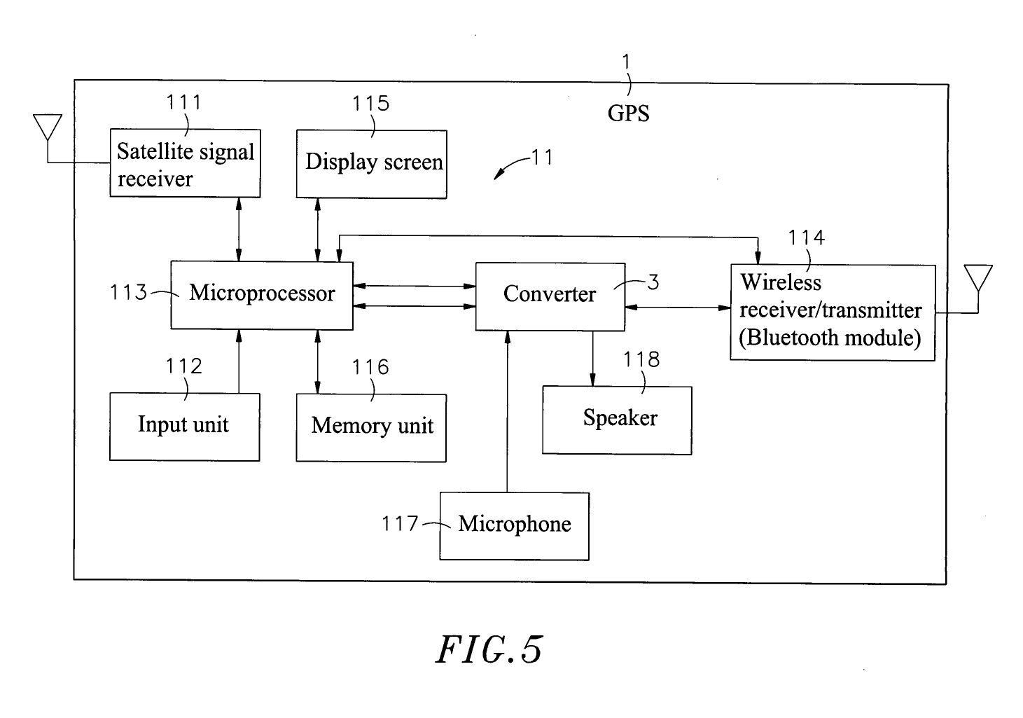

Referring to FIGS. 1, 2, 4 and 5, a GPS remote transmission method in accordance with the present invention is performed subject to the following steps:
(100) Use the satellite signal receiver 111 of the built-in control circuit module 11 of a proximal GPS (Global Positioning System) 1 to receive satellite positioning data including route, travel path and location within the detected zone for integration by the microprocessor 113 of the control circuit module 11 into a satellite positioning data signal.
(101) The converter circuit 3 of the control circuit module 11 of the proximal GPS 1 converts the integrated satellite positioning data signal from the microprocessor 113 into a speech signal.
(102) The wireless receiver/transmitter 114 of the proximal GPS 1 transits the speech signal to a proximal mobile telephone 2, enabling the wireless receiver/transmitter 211 of the built-in circuit module 21 of the proximal mobile telephone 2 to receive the speech signal.
(103) The wireless receiver/transmitter 211 of the built-in circuit module 21 of the proximal mobile telephone 2 transmits the speech signal to a proximal base station 4, enabling the proximal base station 4 to transmit the speech signal to an exchange system 5, which in turns transmits the speech signal to a distal base station 40.
(104) The distal base station 40 transmits the speech signal to a distal mobile telephone 20.
(105) The wireless receiver/transmitter 211 of the built-in circuit module 21 of the distal mobile telephone 20 transmits the speech signal to the microprocessor 212 of the built-in circuit module 21 for recognition, for enabling the speech signal to be transmitted by the distal mobile telephone 20 to a distal GPS 10 after signal recognition.
(106) The wireless receiver/transmitter 114 of the built-in control circuit module 11 of the distal GPS 10 receives the speech signal.
(107) The converter circuit 3 of the built-in control circuit module 11 of the distal GPS 10 converts the speech signal into a satellite positioning data signal for display on a display screen 115 of the built-in control circuit module 11 of the distal GPS 10.

The GPS remote transmission method can be used in a vehicle team in which each vehicle carries one GPS and one mobile telephone, facilitating management of the navigation of the vehicles and avoiding loss contact of any vehicle from the vehicle team during navigation, the GPS and mobile telephone carried in one vehicle of the vehicle team are assigned to be the proximal GPS 1 and the proximal mobile telephone 2 while the GPS and mobile telephones carried in the other vehicles of the vehicle team are distal GPS 10 and distal mobile telephones 20. Upon receive of a satellite positioning data by the proximal GPS 1, the proximal GPS 1 converts through the converter 3 thereof the satellite positioning data into a speech signal and then the proximal mobile telephone 2 receives the speech signal wirelessly from the proximal GPS 1 and then transmits the speech signal to the distal mobile telephone 20 of each of the other vehicles of the vehicle team via base stations 4 and 40 so that the distal GPS 10 of each of the other vehicles of the vehicle team can receive the speech signal wirelessly from the respective distal mobile telephone 20 and display the message on the respective display screen 115.

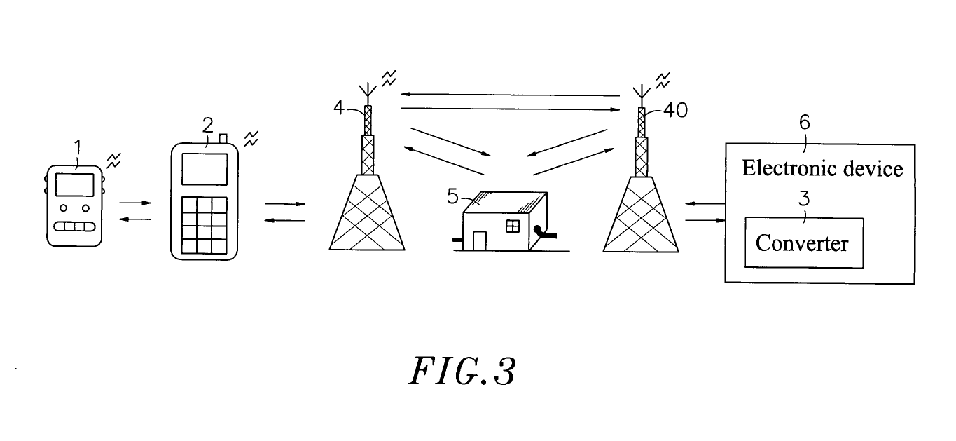

Referring to FIG. 3 and FIGS. 1 and 2 again, as another application example of the present invention, a proximal GPS 1 receives a satellite positioning data and converts the satellite positioning data into a speech signal by a converter 3 therein and then transmits the speech signal to a proximal mobile telephone 2 wirelessly. Then, the proximal mobile telephone 2 transmits the speech signal to a proximal base station 4. Then, the proximal base station 4 transmits the speech signal to an exchange system 5, which in turns transmits the speech signal to a distal base station 40. Upon receipt of the speech signal, the distal base station 40 transmits the speech signal to a distal electronic device 6 wirelessly. The distal electronic device 6 converts the speech signal into a satellite positioning data by an internal converter 3 for display on a display screen of the distal electronic device 6. The distal electronic device 6 can be a desk computer, notebook computer, PDA (personal data assistant), multimedia player, mobile telephone or GPS.

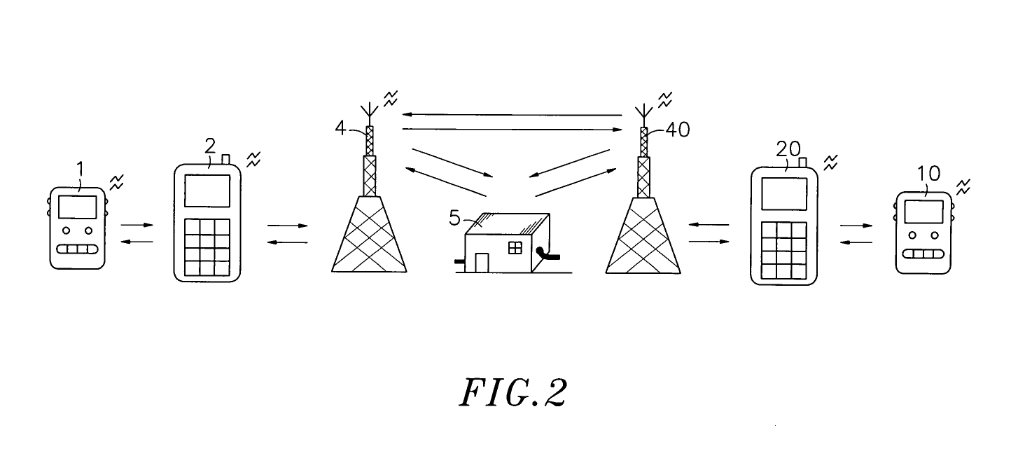

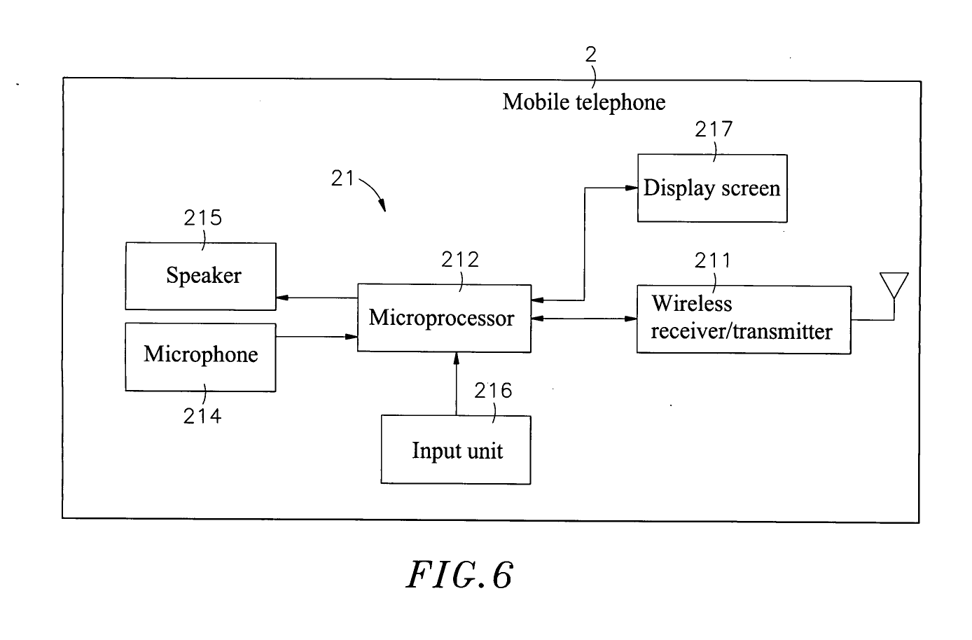

Referring to FIGS. 2, 3, 5 and 6 again, a GPS 1 or 10 in accordance with the present invention has built therein a control circuit module 11. The control circuit module 11 comprises a satellite receiver 111, an input unit 112, a microprocessor 113, a wireless receiver/transmitter 114, a display screen 115, a memory unit 116 and a converter 3. The microprocessor 113 controls the satellite receiver 111 to receive the satellite positioning data of route, travel path and location in the respective zone, and then processes the data into a graphic/text signal, and then drives the converter 3 to convert the graphic/text signal into a speech signal, and then drives the wireless receiver/transmitter 114 to transmit the speech signal into the air. The control circuit module 11 further comprises a microphone 117 for converting sound into an electrical signal, and a speaker 118 for converting an electrical signal into sound.

Subject to the respective frequency value, a speech signal been transmitted by the GPS 1 provides a respective transmission code for recognition by the converter 3. For example, during transmission of a speech signal based on the frequency of 250 Hz, 250 Hz 20 mS is defined to be 1, 250 Hz 40 mS is defined to be 1→1, and so on; during transmission of mute, 20 mS is defined to be 0, 40 mS is defined to be 0→0, and so on. Subject to transmission or not transmission of voice and the operation of a UART (Universal Asynchronous Receiver/Transmitter), transmitted format is decoded into data, for example:
(1) 250 Hz (20 mS)→0 Hz (20 mS)→250 Hz (20 sM)→0 Hz (20 mS)→250 Hz (20 mS)→0 Hz (20 mS)→
(2) 250 Hz (40 sM)→0 Hz (40 mS)→250 Hz (40 sM)→0 Hz (40 mS)→
(3) 250 Hz (20 sM)→250 Hz (40 mS)→0 Hz (60 mS)→250 Hz (60 sM)→0 Hz (20 mS)→0 Hz (20 mS)
(4) 250 Hz (20 sM)→250 Hz (40 sM)→0 Hz (120 mS)→250 Hz (20 mS)→0 Hz (60 mS)→

The above signals are analyzed as:
(1) 1→0→1→0→1→0→;

Synchronization bit (101010).
(2) 1→1→0→0→1→1→0→0→;

Prefix code (11001100)
(3) 1→1→1→0→0→0→1→1→1→0→0;

Start bit |← data bits C7 →| Even parity bit Stop bit
(4) 1→1→1→0→0→0→0→0→0→1→0;

Start bit | ← data bits C0 →| Even parity bit Stop bit

The data transmitted is finally analyzed to be C7, C0.

Further, the code of the speech signal to be transmitted can be set as:
1000 Hz= [symbol] 1200 Hz=1 [symbol] 1400 Hz=2 [symbol] 1600 Hz [symbol] 3 [symbol] 1800 Hz=4 [symbol] 2000 Hz [symbol] 5 [symbol] 2200 Hz=6 [symbol] 2400 Hz [symbol] 7 [symbol] 2600 Hz=8 [symbol] 2800 Hz [symbol] 9 [symbol] 3000 Hz=( [symbol] ) [symbol] 3200 Hz=(·) [symbol] 3400 Hz=$.

Thus, the audio frequency to be transmitted: 3400 Hz (0.05 second)→2400 Hz (0.05 second) →1400 Hz (0.05 second) →1200 Hz (0.05 second) →3000 Hz (0.05 second) 1400 Hz (0.05 second) →2000 Hz (0.05 second) →3200 Hz (0.05 second).

The transmission time required: 0.05 second ×8=0.4 second; the audio frequency signal is analyzed to be: $721,24.

Further, the input unit 112 of the built-in control circuit module 11 of the GPS 1 or 10 can be a keypad, touch screen or detachable keyboard; the microprocessor 113 can be an on-chip microprocessor, single-chip microprocessor or CPU, capable of performing speech-to-graphic/text and graphic/text-to-speech signal conversion and signal editing; the wireless receiver/transmitter 114 can be a Bluetooth module, wireless signal receiving/transmitting antenna or GSM/GPR/3G wireless receiver/transmitter module; the display screen 115 can be a LCD screen or touch screen.

Further, by means of the microphone 117 and the speaker 118, the GPS 1 or 10 allows direct talk. When the user's voice is inputted into the GPS 1 or 10 through the microphone 117 or when a speech signal of a remote user's voice is received, the microprocessor 113 recognizes the type of the incoming or outgoing speech signal, and directly transmits the incoming speech signal to a proximal base station for talk or drives the speaker 118 to output the incoming speech signal. If a satellite positioning signal is received, the microprocessor 113 drives the converter 3 to convert the satellite positioning signal into data for display on the display screen 115.

The GPS 1 or 10 can be a satellite navigation system for use in a motor vehicle. Further, the aforesaid control circuit module 11 an be directly built in a Bluetooth earphone set of a mobile telephone 2 so that the mobile telephone 2 can communicate with a distal mobile telephone 20 for satellite navigation and positioning or speech signal transmission.

The distal electronic device 6 has a built-in control circuit and a wireless receiver/transmitter for receiving signal from the

GPS 1 wirelessly. After the type of the signal received from the GPS 1 has been recognized to be a speech, the microprocessor of the built-in control circuit of the distal electronic device 6 drives the microphone and speaker of the distal electronic device 6 for direct talk. Alternatively, the distal electronic device 6 can transmit the received speech signal through the wireless receiver/transmitter thereof to the associating distal GPS 10, which uses the wireless receiver/transmitter 114 and converter 3 of its built-in control circuit module 11 to receive the speech signal and to convert the speech signal into sound for output through the speaker 118 thereof. Thus, the user of the proximal GPS 1 and the user of the distal GPS 10 can make a two-way voice conversation. Further, the GPS 1 can be equipped with a USB or UART connection interface for communication with a computer (PC or notebook). Through the computer, the user can operate the GPS 1 to set or edit data. Thus, a user can set advanced planning and scheduling to have satellite positioning information and route and travel path data be stored in the GPS 1. When using the GPS 1, the user can display the storage data for checking.

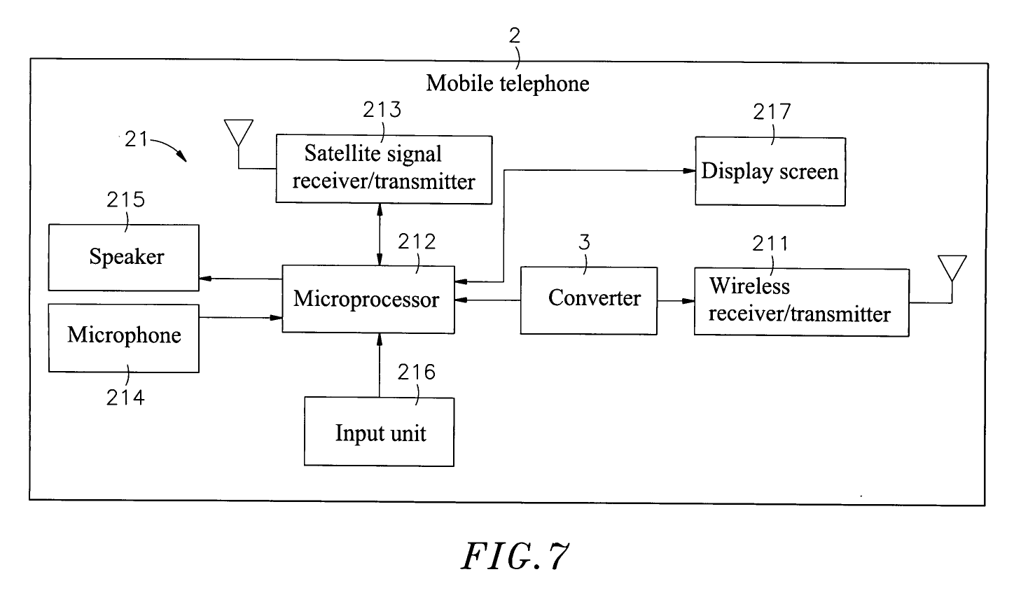

Further, the built-in circuit module 21 of the mobile telephone 2 or 20 comprises a wireless receiver/transmitter 211, a microprocessor 212, a satellite signal receiver/transmitter 213, a microphone 214, a speaker 215, an input unit 216, a display screen 217 and a converter 3 (see FIG. 7). Thus, except talk function, the mobile telephone 2 or 20 can communicate with the GPS 1 wirelessly for conversion and transmission of speech signal and satellite positioning data.

As stated above, the GPS remote transmission method of the present invention enables a distal GPS 1 to convert the received satellite positioning data into a speech signal by a converter 3 and to transmit the speech signal to a distal mobile telephone 2 wirelessly by a wireless receiver/transmitter 114 so that the distal mobile telephone 2 can transmit the speech signal to a distal mobile telephone 20 through a proximal base station 4, an exchange system 5 and a distal base station 40, for enabling the distal mobile telephone 20 to transmit the speech signal to the associating distal GPS 10. Thus, the invention enhances the function of a GPS 1 or 10, enabling the GPS 1 or 10 to transmit satellite positioning data and to make conversion.

In conclusion, the GPS remote transmission method has the following features and advantages:
1. The built-in control circuit module 11 of the GPS 1 or 10 comprises a converter 3, a microphone 117 and a speaker 118 so that the GPS 1 or 10 can convert a graphic/text satellite signal into a speech signal or a speech signal into a graphic/text satellite signal, achieving two-way data transmission.
2. The GPS remote transmission method can be used in a vehicle team in which each vehicle of the vehicle team carries one GPS and one mobile telephone, facilitating management of the navigation of the vehicles and avoiding loss contact of any vehicle from the vehicle team during navigation.

Therefore, the invention provides a GPS remote transmission method, which has a converter and a wireless receiver/transmitter built in the control circuit module of the GPS so that the GPS can make a two-way communication with a remote GPS through a mobile telephone, base stations and an exchange system. The GPS has also built therein a microphone and a speaker to provide a Bluetooth function.

The present invention has been thus disclosed with the preferred embodiment thereof, it will be obvious that various modifications and changes may be made therein without departing from the spirit and scope of the invention as defined in the specification. Accordingly, the invention is not to be limited except as by the appended claims.

What the invention claimed is:

1. A GPS remote transmission method, comprising the steps of:
(a) using a proximal GPS (Global Positioning System) to receive satellite positioning data and to integrate received satellite positioning data into an integrated satellite positioning data signal;
(b) driving a converter to convert the integrated satellite positioning data signal into a speech signal;
(c) enabling the proximal GPS to transit the speech signal to a proximal mobile telephone wirelessly through a wireless receiver/transmitter thereof;
(d) enabling the proximal mobile telephone to transmit the received speech signal to a proximal base station, so that the proximal base station transmits the speech signal to a distal base station through an exchange system;
(e) using the distal base station to transmit the speech signal to a distal mobile telephone;
(f) enabling the distal mobile telephone to transmit the speech signal to a distal GPS;
(g) enabling the distal GPS to convert through a converter thereof the speech signal into a satellite positioning data signal; and
(h) driving a display screen of the distal GPS to display the satellite positioning data signal.

2. The GPS remote transmission method as claimed in claim 1, wherein said proximal GPS has a control circuit module built therein, said control circuit module comprising a satellite signal receiver, a microprocessor, an input unit, a wireless receiver/transmitter, a display screen and a memory unit.

3. The GPS remote transmission method as claimed in claim 2, wherein said input unit is selected from a group of keypad, touch screen and detachable keyboard; said display screen is selected from a group of LCD screen and touch screen.

4. The GPS remote transmission method as claimed in claim 2, wherein said microprocessor of said control circuit module of said proximal GPS is selected from a group of on-chip microprocessor, single-chip microprocessor and CPU, capable of processing and integrating a speech signal and satellite positioning data.

5. The GPS remote transmission method as claimed in claim 2, wherein said wireless receiver/transmitter of said control circuit module of said proximal GPS is selected from a group of Bluetooth module, wireless signal receiving/transmitting antenna and GSM/GPR/3G wireless receiver/transmitter module.

6. The GPS remote transmission method as claimed in claim 1, wherein said proximal mobile telephone and said distal mobile telephone each have a circuit module built therein for signal processing and transmission, said circuit module comprising a microprocessor, a satellite signal receiver/transmitter, a wireless signal receiver/transmitter, an input unit, a speaker, a microphone and a display screen.

7. The GPS remote transmission method as claimed in claim 1, wherein said converter is built in the control circuit module of one of said proximal GPS and said distal GPS.

8. The GPS remote transmission method as claimed in claim 1, wherein the speech signal transmitted between the wireless receiver/transmitter of said proximal GPS and the wireless receiver/transmitter of said proximal mobile telephone provides a respective transmission code determined subject to the value of the frequency carrying the speech signal for recognition by the associating converter.

9. A GPS remote transmission method used in a wireless communication system comprising a proximal GPS (Global Positioning System), said proximal GPS comprising a control circuit module built therein, said control circuit module comprising a satellite signal receiver, a microprocessor, an input unit, a wireless receiver/transmitter and a memory unit, a proximal mobile telephone, said proximal mobile telephone comprising a circuit module built therein for signal conversion and transmission, said circuit module comprising a microprocessor, a wireless receiver/transmitter, an input unit, a microphone, a speaker and a display screen, the GPS remote transmission method comprising the steps of:
(a) using said proximal GPS to receive satellite positioning data and to integrate received satellite positioning data into an integrated satellite positioning data signal;
(b) driving a converter to convert the integrated satellite positioning data signal into a speech signal;
(c) enabling said proximal GPS to transit the speech signal to said proximal mobile telephone wirelessly;
(d) enabling said proximal mobile telephone to transmit the received speech signal to a proximal base station, so that the proximal base station transmits the speech signal to a distal base station through an exchange system;
(e) using said distal base station to transmit the speech signal to a distal electronic device;
(f) enabling said distal electronic device to convert the speech signal into a satellite positioning data signal through a converter;
(g) driving said electronic device to display said satellite positioning data signal on a display screen thereof.

10. The GPS remote transmission method as claimed in claim 9, wherein said distal electronic device is selected from a group of desk computer, notebook computer, personal digital assistant, multimedia player, mobile telephone and global positioning system capable of displaying graphic and text data.

11. The GPS remote transmission method as claimed in claim 9, wherein said input unit is selected from a group of keypad, touch screen and detachable keyboard; said display screen is selected from a group of LCD screen and touch screen.

12. The GPS remote transmission method as claimed in claim 9, wherein said microprocessor of said control circuit module of said proximal GPS is selected from a group of on-chip microprocessor, single-chip microprocessor and CPU, capable of processing and integrating a speech signal and satellite positioning data.

13. The GPS remote transmission method as claimed in claim 9, wherein said wireless receiver/transmitter of said control circuit module of said proximal GPS is selected from a group of Bluetooth module, wireless signal receiving/transmitting antenna and GSM/GPR/3G wireless receiver/transmitter module.

14. The GPS remote transmission method as claimed in claim 9, wherein said converter is built in each of the control circuit module of said proximal GPS and said distal GPS.

15. The GPS remote transmission method as claimed in claim 9, wherein the speech signal transmitted between the wireless receiver/transmitter of said proximal GPS and the wireless receiver/transmitter of said proximal mobile telephone provides a transmission code determined subject to the value of the frequency carrying the speech signal for recognition by the associating converter.

16. The GPS remote transmission method as claimed in claim 9, wherein said control circuit module of said proximal GPS has built therein a display screen for displaying images and graphic/text data signal.
